(19) United States
(12) Patent Application Publication
(10) Pub. No.: US 2025/0272693 A1
(43) Pub. Date: Aug. 28, 2025

(54) AGGREGATED TRANSACTION ACCOUNTS

(71) Applicant: Joseph Wayne Stafford, Atlanta, GA (US)

(72) Inventor: Joseph Wayne Stafford, Atlanta, GA (US)

(21) Appl. No.: 19/205,956

(22) Filed: May 12, 2025

Related U.S. Application Data
(63) Continuation of application No. 17/986,253, filed on Nov. 14, 2022.
Application No. 17/986,253 is a continuation of application No. 17/403,328, filed on Aug. 16, 2021, now abandoned.
Application No. 17/403,328 is a continuation of application No. 17/068,763, filed on Oct. 12, 2020, now abandoned.

(51) Int. Cl. G06Q 20/40; G06Q 20/20; G06Q 20/32; G06Q 30/018; G06Q 40/02

(52) U.S. Cl. CPC G06Q 20/405; G06Q 20/4037; G06Q 40/02; G06Q 20/202; G06Q 20/204; G06Q 20/3278; G06Q 20/4018; G06Q 30/0185

(57) ABSTRACT

System and method to process electronic financial transactions using an aggregated transaction account are described. Embodiments may include an application server configured to perform processing functions, and an updating module configured to retrieve and update the financial account data in a verified user account profile in real-time. Embodiments may also include a transaction processing module configured to receive and process authorization requests. This module may be configured to develop a payment solution for an authorization request initiated, where the method of payment is linked to its assigned aggregated transaction account with an available credit balance funded by one or more authorized funding transaction accounts according to governing policies and reference databases. System and method can be used to process card-present and non-card-present transactions, and does not place a limit on the number of acceptable methods of payment used to fund the available credit balance of the aggregated transaction account.

### CROSS-REFERENCE TO RELATED APPLICATIONS

The present application is a continuation-in-part of U.S. patent application Ser. No. 17/986,253, filed Nov. 14, 2022; which is a continuation of U.S. patent application Ser. No. 17/403,328, filed Aug. 16, 2021 (now abandoned); which is a continuation of U.S. patent application Ser. No. 17/068,763, filed Oct. 12, 2020 (now abandoned); all which are incorporated herein in their entirety and referenced thereto.

### BACKGROUND OF THE INVENTION

### Field of the Invention

Legacy programs commonly used to process payments have largely remained the same since they were first introduced and have not kept pace with the changing financial landscape.

The prior art of payment processing has been slow to respond to customer demand, market shifts, and new technologies.

The trend toward e-commerce transactions is unfolding in ways that were once considered unimaginable. Exponential growth, driven by technological advancements, shifting consumer preferences, the use of mobile devices, and a changing financial environment has fundamentally changed how merchants conduct business and consumers pay for their purchases.

An increasing number of consumers rely on their cards to pay for virtually everything throughout the day.

While there are obvious benefits to using a card as a preferred method of payment, the art of payment processing has not kept pace with the changing payment landscape. The systems and methods currently used to process payments have remained fundamentally the same over the years. It is apparent to those having skill in the art, the negative impact of the restrictions, limitations, and deficiencies of the prior art currently used to process payments. Tens of millions of transactions are declined every day. The negative impact of a single limitation in the system commonly used to process payments affects not only the average consumer but the impact on low-income individuals, people of color, Hispanics and Latinos, individuals with multiple credit cards with low credit limits, and the struggling number of underserved credit-invisible invisible can be devastating.

The unintended consequences of many of the restrictions, limitations, and deficiencies of the prior art are impacting payment processing in ways that could not have been predicted.

The payment processing environment has grown beyond the boundaries of the legacy programs commonly used to process payments.

Issuers, processors, payment networks, consumers, and merchants have historically relied on advancements in new and developing technologies to develop innovative solutions that better align with consumer needs. Solutions that seamlessly integrate with the program commonly used to process payments and for problems

Embodiments of the invention are directed to providing a practical and useful solution for a specific restriction in the prior art of payment processing that limits the number of methods of payment that can be used to process a single payment transaction to a maximum of two. Even then the maximum of two methods of payment is subject to its own policies and hardware requirements.

The unintended consequence of this specific limitation negatively affects tens of millions of transactions every day in the U.S.

Embodiments of the invention are directed at providing a solution to the problem at its source. A technical solution that seamlessly integrates with the programs commonly used to process payments and expands its usefulness.

The invention provides consumers with a useful and practical solution for the problems experienced as a direct result of this specific limitation and restriction in the prior art.

Embodiments of the present invention provide consumers with the ability to access and use the combined resources of their available credit linked to a method of payment to pay for their purchases. A method of payment linked to an aggregated transaction account and specialized programming to provide an available credit balance required to process transactions. requirement using a source of funds are directed at providing a practical and useful solution to processing financial transactions using one or multiple funding sources.

More specifically, a payment solution where the method of payment is linked to an aggregated transaction account and available credit balance using a source of funds authorized to provide a funding solution using the available credit of one or more existing credit card accounts, debit card accounts, or other acceptable financial accounts categorized as a transaction account. The available credit balance of an account categorized as a transaction account can be used either individually or in combination with other transaction accounts as an available source of funds as may be required.

A transaction processing engine of the transaction processing module may be configured to develop and execute a funding solution for an authorization request initiated by a method of payment linked to an aggregated transaction account. a source of funds and funding resources using the existing available credit balance of one or more of a plurality of linked transaction funding accounts and generate an available credit balance in the amount required by the aggregated transaction account to provide a response to the payment request initiated by a linked method of payment.

It can be difficult for consumers with multiple cards and used multiple times throughout the day to track the available credit balance of one or more methods of payment. The scope of many of the patents issued are often directed toward providing a limited solution to a problem experienced by a narrowly defined target market of consumers. Solutions for authorization requests that can be processed unrestrained or subject to a self-imposed time requirement. Conditional solutions that can only be used within the boundaries of a defined environment or conditional circumstance. Some of these issues are partially addressed by existing systems described below.

### Description of the Prior Art

US Patent Publication No. 2018/0150829 A1 titled “System and method for use in performing an electronic transaction with a smart card” teaches to perform electronic transactions between a user and a merchant. In this patent application, a user is associated with multiple virtual payment cards. When transaction information indicative of one or more parameters of the transaction between the user and merchant is received, using the transaction information and transaction rules, a single virtual payment card is selected. The selected single virtual payment card is used to perform the transaction. This application merely teaches them to eliminate the burden of possessing physical financial cards by the user. A smart card that holds information about all the physical financial cards in form of virtual payment cards is proposed. However, for a transaction with the selected single virtual payment card, the user still has to perform the required authentication and authorization to complete the transaction. The transaction rules, which indicate card usage, are merely used for selecting a single virtual payment card. For a transaction that does not match the transaction rules, the system of this application may not be able to find a match of the virtual payment card.

U.S. Pat. No. 10,803,457 B2 titled “System for coordinating access to multiple accounts using a single access card” teaches to access multiple accounts located at and/or managed by different organizations/providers/issuers, by providing secure exchanges of the necessary information so that multiple login details are not necessary. The system of this patent includes a card reader, an account management system, and a passive card that stores details of at least one account of the plurality of accounts of a user. The card reader reads the stored details in the passive card and the account management system receives the read information and recognize the plurality of accounts tied to the passive card within the account management system. The account management system communicates with the account holding organizations comprising a financial institution and a loyalty program. Such communication mechanisms will allow a user to securely access any selected account among the multiple accounts. The '457 patent merely teaches a method for eliminating the need to provide PIN or access codes each time for a transaction using multiple accounts. Also, a system of '457 patent prompts the user to select a single account amongst the multiple accounts to process the transaction. The '457 patent does not address the problem of fulfilling a transaction irrespective of the balance or credit limits of individual transaction accounts.

U.S. Pat. No. 10,185,959 B2 titled “Shared pools for common transactions” teaches to set up a shared pool to receive funds from multiple users. The '959 patent solves the problem associated with making payments by a group of users for a common expense. The shared pool is created with funds received from funding sources, i.e., transaction accounts of the users, and associated rules for each of the funding sources. The rules indicate the percentage amount split related to the funding sources for the pulling of funds to the shared pool. A user sets the rules. When a request to use the shared pool is received then the user is provided with an option to accept or decline participation to pull funds from the funding sources to complete the transaction. The ‘959’ patent handles the transaction accounts of multiple users where funding from each transaction account is predefined. The system and method of this patent may not be implementable for a scenario where a transaction is to be performed with multiple transaction accounts of a single user. This patent does not address the problem of fulfilling a transaction irrespective of the balance or credit limits of individual transaction accounts.

The scope of many of the patents previously issued are often directed toward providing a solution for a problem experienced by a narrowly defined target market of either financially qualified consumers or controlled environment. Embodiments of the invention are directed toward providing a solution to a problem and unintended consequences of a specific restriction in the current art commonly used to process electronic financial transactions. A restriction known to those familiar with the prior art that limits the number of methods of payment that can be used to process any one transaction.

The shift away from cash and the adoption of credit cards and debit cards as the preferred method of payment has been dramatic and isn't expected to change. As consumers increasingly rely on their cards and use them multiple times throughout the day, it becomes increasingly important for them to know how much credit they have, on what card, and all of the data conveniently displayed in one location. A critical need for a growing number of consumers is the ability to combine and use more of their available credit when they need it.

The complex web of relationships and interactions between financial institutions, markets, regulators, consumers, and technology has changed in ways that were once considered unimaginable. Consumers, merchants, issuers, payment processors, and payment networks have historically relied on advancements in new and developing technologies to provide innovative solutions that better align with the changing needs of the payment processing environment.

The invention provides a useful and practical solution for the unintended consequences of a specific limitation in the system commonly used to process electronic financial transactions. A solution that includes providing consumers with a method of payment linked to the available credit balance of an aggregated transaction account. A processing solution of systems, methods, and special purpose programming required to develop and execute a payment solution to a payment request initiated by the linked method of payment using the available credit balance of a source of funds provided by the available credit balance of one or more credit cards, debit cards, and financial accounts categorized as transaction accounts. Transaction accounts can be used individually or in combination with other transaction accounts to provide a funding solution for the aggregated transaction account's funding requirement.

The use of digital payment systems has witnessed unprecedented growth in ways that were once considered impossible. While digital payments have brought significant benefits to our lives, there are still some scenarios where these systems have failed miserably.

One of the current challenges across digital and physical environments is that payment options are limited.

Clearly, the prior art commonly used to process ecommerce payments has not kept pace with the changing needs of consumers and merchants. Legacy programming and policies that are not expected to change anytime soon. The need to provide a solution to the problem is undeniable. Have perpetuated many of

The invention provides consumers with the features and benefits they want, need, and are looking for. An easy-to-use, no-frills application for the information they need throughout the day, conveniently displayed in one mobile app and used to pay for purchases.

### SUMMARY OF THE INVENTION

The information provided in this summary background of the disclosure section is intended to enhance understanding of the general background of the disclosure and should not be taken as an acknowledgment or suggestion that this information is already known to those skilled in the art.

The invention is directed to providing a solution to the problems and unintended consequences of a specific limitation in the prior art that restricts the number of methods of payment that can be used to process a transaction to a maximum of two. More specifically, embodiments of the present invention provide a system to process electronic financial transactions with a method of payment linked to an aggregated transaction account.

A system to process electronic financial transactions using an aggregated transaction account is disclosed. An exemplary embodiment of the invention, and a mandatory prerequisite of the new applicant registration process, is the generation and assignment of a unique aggregated transaction account number for every pre-approved applicant without exception. Pursuant to embodiments of the invention, the aggregated transaction account may have an available credit balance associated with one or multiple funding sources. The application server processing may include and/or be comprised of a plurality of engines, modules, and plugins configured with specialized programming to perform one or more functions performed by embodiments of the invention.

The system may include an application server that may include one or more modules, plugins, forms of memory, programming, and specialized programming for the functions performed by embodiments of the invention. The application server may contain a communications module that may include a receiving module configured to simultaneously receive a plurality of electronically transmitted data signals using one or more network protocols from a linked application, acquirers, processors, servers, mobile phones, tablets, merchant devices, issuers, payment networks, data aggregators, data providers, banks, payment providers, credit/debit card networks, government entities, other financial accounts, and other compatible devices or other data sources required by the systems and methods to perform embodiments of the invention and entities via alternative and compatible networks and application-supported programming. The receiving module may comprise multiple devices, such as different receiving devices configured to receive data signals from one or more networks via one or more network protocols. The receiving module may also be configured with special-purpose programming to interface with one or more modules, plugins, databases, or memories of the application server to simultaneously receive multiple data responses to multiple data requests. The communications module may also include a transmitting module configured to simultaneously transmit a plurality of electronically transmitted data signals over one or more networks via one or more network protocols. In some embodiments of the invention, the transmitting device may be configured to transmit data over the payment rails, using specially configured infrastructure associated with payment networks for the transmission of transaction messages that include sensitive financial data and information. The transmitting module may be configured to simultaneously transmit multiple data signals to one or more authorized user devices, issuers, payment networks, and other entities via payment rails or alternative communication networks used to process payment transactions. The transmitting module may electronically transmit data signals that have data superimposed, which can be parsed by a receiving computing device. It may include one or more modules for superimposing, encoding, or otherwise formatting data into data signals suitable for transmission. The transmitting module may be configured to electronically transmit data signals to a mobile user device via suitable communication networks superimposed with data messages associated with the use and management of a linked transaction account, such as authorization responses, confirmation messages, notifications, account data, transaction messaging etc. Additionally, the transmitting module may also be configured to transmit data signals superimposed with payment credentials for provisioning payment credentials to a linked transaction account on the device. The transmitting module may also be configured with special-purpose programming to interface with one or more modules, plugins, databases, or memories of the application server to simultaneously transmit multiple data requests to credit and debit card issuers, banks, credit providers, data aggregators, and other financial service providers. The transmitting module may also be configured to electronically transmit transaction messages, which may include providing an authorization response to a payment request, to payment networks and issuers, and others via the payment rails or a suitable alternative communication network for payment transactions.

The application server may include an application programming module. The application programming module may contain specialized programming configured to transmit data between modules, engines, databases, memories, and other components of the application server for use in performing the functions discussed herein. The application programming module may be comprised of one or more communication types and utilize various communication methods for internal communications within the application server. In addition, it may also be configured to communicate between internal modules and components of the application server and external components of the application server, such as externally connected databases, service providers, data aggregators, credit and debit card issuers, banks, financial service providers, display devices, input devices, etc. The application programming module may contain one or more specialized programs and platforms of integrated systems, methods, and special-purpose programming configured to perform the embodiments of the invention.

The application server may include a querying module. The querying module may be configured to execute queries on modules, plugins, databases, and forms of memory of the application server to identify, confirm, or collect information. It may be programmed to receive one or more internally generated data values or query strings, process and execute the query string as directed according to output the identified or collected information to the appropriate engine, module, or plugin of the application server.

The application server may include an updating module. The updating module may be configured with special purpose programming to execute the module's functional requirements in accordance with exemplary embodiments of the invention. The updating module may be configured to update data stored in the various modules, plugins, and related memory files of the processing server. The updating module may be configured to respond to an update request initiated internally by a module, plugin, or processing platform of the application server such as the querying module, transaction processing module, or the application processing module. The module may be configured with special-purpose programming to simultaneously transmit and receive multiple data requests and data responses and output the updated data to update related files stored in the application server. Additionally, the updating module may be configured to update the user account profile data on the associated mobile device.

The application server may also include a transaction processing module configured with specialized programming to process transactions linked to an aggregated transaction account. In an exemplary embodiment of the invention, the transaction processing module may include a separate database of user account profiles exclusively used to process authorization requests. The transaction processing module may be configured to receive authorization requests, triggering the program to retrieve the tokenized account identification and transaction data and proceed to retrieve and update the user account profile data. The transaction processing module may be programmed to simultaneously transmit one or multiple account update requests to credit and debit card issuers, credit providers, banks, data aggregators, and other financial account and service providers and simultaneously receive corresponding data responses to the update request(s). The transaction processing module may then proceed to evaluate and process the authorization request. The module's specialized programming is configured to evaluate the authorization request and proceed to develop and execute a payment solution. The payment solution can be developed according to the user's account preferences, selected by the user in real-time or by default, and processed according to the user's account management and transaction processing presets configured as part of the new applicant registration. An exemplary embodiment of the invention, payment solution programming does not include a limitation restricting the number of accounts that can be used in the development of the proposed solution. The transaction processing module may include programming to determine approval or denial of the payment transaction based on transaction controls, account balances and/or credit limits, fraud rules, and other considerations based on the transaction data. Additionally, the transaction processing module may be configured to transmit an authorization response to the authorization request, and a separate message detailing the transaction is transmitted to the user's mobile device that may include detailed transaction information and suggestions on how to proceed if the authorization was declined.

These and other objects of the present invention will be apparent from review of the following specification and the accompanying drawings.

### BRIEF DESCRIPTION OF THE DRAWINGS

The modules and plugins of the block diagrams and flowchart illustrations may be configured with specialized programming, support processes, sequences of steps, and logic flow for performing specific functions. Embodiments of the present disclosure are best understood when read in conjunction with the accompanying drawings. It will also be understood that each functional block of the block diagrams and flowchart illustrations, or combination of functional blocks in the block diagrams and flowchart illustrations, can be implemented by either special purpose hardware-based computer systems to perform the specified function or steps, or a suitable combination of special purpose hardware and computer instructions. The modules and plugins of the block diagrams and flowchart illustrations support combinations of means for performing the specified functions, sequences of steps for performing the specified functions, and special-purpose programming required to execute the specific function. The modules and plugins of the block diagrams and flowchart illustrations, configured with specialized programming, support the processes, sequences of steps, and logic flow for performing specific functions.

Included in the drawings are the following figures:

FIG. 1A is a flow chart illustrating the fundamental steps that take place in the system commonly used to process electronic transactions.

FIG. 1B is a flow chart illustrating the fundamental steps that take place in the system commonly used to process electronic transactions using a method of payment linked to an aggregated transaction account.

FIG. 2 is a flow diagram illustrating the ability of the modules of the application server to interface with other modules in accordance with exemplary embodiments.

FIG. 3A is a block diagram of a modules-only configuration illustrating a possible example of the programming relationship between the host program of the application programming module, processing modules, and memory to perform in accordance with the functions performed by embodiments of the invention.

FIG. 3B In addition to the description provided in FIG. 3A, diagram 3B illustrates the possible integration of plugins configured to contain specialized programming and defined interface required to expand, extend, and/or increase the performance the capabilities of the application server in accordance with embodiments of an invention.

FIG. 4 is a block diagram illustrating exemplary actions performed by a notifications platform programmed to communicate with a registered user in accordance with embodiments of the present disclosure.

FIG. 5 is a flow diagram illustrating the registration process that new applicants are required to complete and submit for approval. In addition, FIG. 5 illustrates the programming requirements that must be completed to create an authorized and registered user account in accordance with embodiments of the invention.

FIG. 6 is a flow chart illustrating the process of updating a verified user's financial account information in accordance with embodiments of the present disclosure.

FIG. 7 illustrates a block diagram of a mobile application on a mobile device in accordance with embodiments of the present disclosure.

FIG. 8 is a block diagram illustrating the processing of a card-present payment initiated by a method of payment linked to an aggregated transaction account in accordance with embodiments of the present disclosure.

FIG. 9 is a block diagram illustrating the processing of a payment from a mobile device initiated by a method of payment linked to an aggregated transaction account in accordance with embodiments of the present disclosure.

### DETAILED DESCRIPTION OF THE PREFERRED EMBODIMENT

The detailed description set forth below in connection with the appended drawings is intended as a description of exemplary embodiments in which the present disclosure can be practiced. Before explaining at least one embodiment of the present invention in detail, it is to be understood that the invention is not limited in its application to the details of construction and to the arrangements of the components set forth in the following description or illustrated in the drawings or figures of the application. The invention is capable of other embodiments and of being practiced and carried out in various ways. Also, it is to be understood that the phraseology and terminology employed herein are for the purpose of description and should not be regarded as limiting.

The word “card” is used herein consistently is any method of payment used to make purchases or make payments from a financial account. However, this method of payment may or may not be associated with a physical, plastic, credit card or debit card of any type, either at the time of purchase or in general. Furthermore, the card may represent a non-traditional account and may vary from traditional processing methods. As financial technology evolves, it is anticipated that physical plastic cards will be used less and less and replaced with devices and methods offering consumers and merchants greater flexibility, increased security, and improved affordability. In addition, card-present and card-not-present purchases may use simple account identification and verification data parameters or tokens that may also include an account data request, a payment authorization request, or other information that may not be associated with an actual card but may be associated with a linked account. Therefore, the word “card” used in this application need not imply the use or existence of an actual card. This invention is designed to be used with any current or future payment method of payment that links purchases or payments to a financial account that may include an aggregated transaction account.

For the purpose of this description, aggregated transaction mobile application 700 may also be referred to as aggregated transaction mobile app 700, mobile application 700, mobile app 700, or simply as “the app” when used in context.

For the purpose of this description, the terms “special purpose programming,” “specialized programming,” and “specialized program instruction” are interchangeable.

For the purpose of this disclosure, an aggregated transaction account is an account where multiple transactions are merged into one account as performed by embodiments of the disclosure.

As used in the description herein and throughout the claims that follow, the terms “source of funds” and “funding account(s)” are interchangeable unless the context dictates otherwise and shall mean one or more registered financial accounts categorized or identified as a transaction account.

The detailed description set forth below in connection with the appended drawings is intended as a description of exemplary embodiments in which the presently disclosed disclosure can be practiced. The term “exemplary,” used throughout this description, means “serving as an example, instance, or illustration,” and should not necessarily be construed as preferred or advantageous over other embodiments. The detailed description includes specific details for providing a thorough understanding of the presently disclosed disclosure. However, it will be apparent to those skilled in the art that the presently disclosed disclosure may be practiced without these specific details. In some instances, well-known structures and devices are illustrated in block diagram form to avoid obscuring the concepts of the presently disclosed invention.

Embodiments of the present disclosure include various steps, which will be described below. The invention is designed to operate on a number of different platforms that include, but not limited to, personal computers, mobile devices, remote computer networks, servers, and cloud computing environments configured to execute embodiments and special-purpose programming of the invention. A mobile device hardware components or may be embodied in machine-executable instructions, which may be used to cause a general-purpose or special-purpose processor programmed with the invention's special-purpose programming for the function performed by embodiments of the invention. Alternatively, steps may be performed by a combination of hardware, software, and/or firmware.

Embodiments of the present disclosure may be provided as a computer program product, which may include a non-transitory, machine-readable storage medium tangibly embodying thereon instructions, which may be used to program the computer (or other electronic devices) to perform a process. The machine-readable medium may include, but is not limited to, fixed (hard) drives, semiconductor memories, such as Read Only Memories (ROMs), Programmable Read-Only Memories (PROMs), Random Access Memories (RAMs), Erasable PROMs (EPROMs), Electrically Erasable PROMs (EEPROMs), flash memory or other types of media/machine-readable medium suitable for storing electronic instructions (e.g., computer programming code, such as software or firmware).

Various methods described herein may be practiced by combining one or more non-transitory, machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection. Based on the disclosure provided herein, one of ordinary skill in the art will appreciate a variety of ways in which connection or coupling exists in accordance with the aforementioned definition.

Further, the term “module” may be software or hardware specifically programmed to receive an input, perform one or more processes using the input, and provide an output. The input, output, and processes performed by various modules will be apparent to one skilled in the art based on the present disclosure. Modules may contain special-purpose programming to perform specific functions independently or in association with one or more other modules and/or plugins of the application server. When used in the description of systems, methods, steps, or performance of the invention, it is understood by persons skilled in the art that the word “module” or “modules” may imply using one or more plugins when used as a means of performing its specific function.

In addition, the term “plugin” is a software component that adds specific functionality and extends the capabilities by integrating with the host application through a defined interface. Plugins may contain special-purpose programming to perform specific functions independently or in association with one or more of the plugins or modules of the application server.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments refer to specific examples that are provided within the patent specification. These examples serve as illustrations, demonstrating how the invention can be put into practice to provide additional clarity, context, and practical examples of the invention. Preferred embodiments refer to specific examples of the invention that the inventor considers to be the best or most favorable. These embodiments represent the inventor's preferred implementation of the invention, highlighting the features or aspects that they believe are most advantageous. While other embodiments may exist, the preferred embodiments are presented as the optimal choices. It is important to note that exemplary embodiments and preferred embodiments are not mutually exclusive. In many cases, preferred embodiments may also be included as exemplary embodiments, providing a comprehensive range of examples for the invention. The inclusion of both types of embodiments enables the specification to cover a broader scope and accommodate various scenarios or preferences.

It will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as dedicated hardware capable of executing special-purpose software. Functional elements of the invention may be carried out through the operation of program logic, dedicated logic, the interaction of program control and dedicated logic, or even manually, with the particular technique being selectable by the entity implementing this disclosure. Accordingly, diagrams, schematics, illustrations, and flowchart illustrations support combinations of the systems and methods for performing the specified functions, implemented by special purpose hardware-based computer systems required to perform the specified functions or steps, or suitable combinations of special purpose hardware and specialized programming (special purpose programming) instruction means for performing the specified functions. Those of ordinary skill in the art further understand that the exemplary hardware, software, processes, methods, and/or operating systems described herein are for illustrative purposes and, thus, are not intended to be limited to any particular name.

The invention is designed to operate on various platforms, including, but not limited to, personal computers, mobile devices, remote computer networks, and cloud computing servers.

The invention has been designed to operate both domestically and internationally, supporting multiple languages and multiple currencies.

It will be apparent to those having skill in the relevant art, the systems, methods, and programming commonly used to process e-commerce authorization payment requests are processed according to the limitations, restrictions, and operating policies contained in the prior art.

Embodiments of the invention described herein are directed toward providing a practical and useful real-world solution to a specific limitation in the prior art commonly used to process electronic financial transactions. A specific limitation in the technology restricts the number of methods of payment that can be used to process a single transaction to a maximum of two.

More specifically, embodiments of the present disclosure relate to processing electronic transactions with a method of payment linked to an aggregated transaction account. A technical solution to a technical problem that negatively impacts tens of millions of ecommerce transactions every day. The invention provides a practical solution to a specific limitation in the prior art, integrates seamlessly with the systems and methods commonly used to process electronic transactions, enhances and expands its usefulness without amendment. A solution for low-income, underbanked, and otherwise victimized consumers with multiple cards and low credit limits that otherwise would have little choice but to use expensive, predatory financial service alternatives.

Issuers, merchant acquirers, payment processors, processing networks, consumers, and merchants have relied on service providers to use advancements in new and emerging technologies to develop practical and useful real-world solutions that align with their changing needs. Embodiments of the invention provide consumers with a novel and practical solution to a specific limitation in the art of payment processing, expanding its use, and providing significant benefits to both merchants and consumers.

Embodiments of the present disclosure relate to a system, method, and specialized programming for processing a payment request where the method of payment is linked to an aggregated transaction account. Pursuant to embodiments of the invention, the aggregated transaction account may have an available credit balance linked to one or more funding sources. In an embodiment of the present disclosure, an application server may include one or more modules, plugins, databases, engines, specialized programs, and forms of memory for the functions performed by embodiments of the invention. An embodiment of the invention, a mandatory requirement of the new applicant registration process, the generation module of the application server is programmed to automatically generate and assign a unique aggregated transaction account number for every pre-approved applicant. The generation module generates a transaction

A system for processing electronic financial transactions using an aggregated transaction account is disclosed. The system may include an application server operating in a cloud-based computing environment. It will be apparent to persons having skill in the relevant art that modules and plugins of the application server may be configured to contain specialized programming configured to simultaneously communicate internally and externally with multiple engines, modules, databases, memories, and specialized programming as may be required to carry out the functions of the invention. The application server may contain a communications module that includes a receiving module configured to receive multiple data transmissions simultaneously. The communications module may also include a transmitting module configured to transmit multiple data signals simultaneously. It may be noted that data transmissions received by the receiving module may be configured to share the data received with one or more modules and plugins according to the application programming module of the application server. Further, each module may contain and execute special purpose programming as may be required to process data according to the module's programming priorities.

The processing server may include an updating module configured to retrieve and update the user account profile data of a specified user. The updating module may contain specialized programming authorizing it to communicate internally and externally with multiple engines, modules, databases, and memory as required to execute embodiments of the invention. In addition, the updating module may be configured with special-purpose programming to transmit a data request to and receive a data response from one or multiple accounts simultaneously. It may be noted that the updating module may be programmed to share the data received with one or more of the modules and plugins of the application server. For example, response data may be used to update the available credit balance for each of the accounts retrieved from the user account profile, account database, and profile memory.

In an embodiment of the present disclosure, the updating module may receive a data request to add a new account, remove an existing account, update existing account data, change the designated category of an existing account, or modify the account information and management policies of an existing registered account.

The system may also include a querying module configured to execute queries on the modules, databases, and memory of the application server to identify, confirm, or collect data. The querying module may be programmed to receive one or more data values or query strings and execute a query string on a specific database or memory file. The query file may also contain programming to provide a response to the appropriate engine or module as directed by the query string.

In addition, the system may include a transaction processing module. The transaction processing module may be configured to process “card present” and “card not present” payment transactions. The transaction processing module may contain special-purpose programming configured to process transaction requests initiated by a method of payment linked to an aggregated transaction account. In an exemplary embodiment of the invention, the aggregated transaction account may contain specialized programming to process an authorization request with an available credit balance where the source of fundsregistered transaction account stored in the digital wallet of aggregated transaction mobile app 700. The transaction processing module may also contain programming configured to process single-card transactions in response to an authorization request of individual registered transaction accounts, including the account linked to an aggregated transaction account, initiated by the digital wallet of the aggregated transaction mobile app. The transaction processing module may be further configured to process card present transactions where the card's method of payment is linked to an aggregated transaction account.

On the surface, “card-present” and “card-not-present” seem like self-explanatory terms. Either the card was present at the time of a transaction, or it was not present. More than just the physical presence of the credit card, a transaction is considered ‘card-present’ only if electronic data is captured at the time of the sale. You can capture data by swiping a magnetic strip card, dipping an EMV chip card, or tapping an NFC/contactless digital wallet with a stored card. Card-present transaction methods include POS Systems with card readers, contactless-enabled terminals, and card readers connected to smartphones or tablets. Card-not-present transaction methods include Online shopping carts, “Buy” buttons on websites. Recurring or subscription billing, electronic invoicing, Orders taken over the phone and manually entered, and Payment apps on smartphones or tablets that don't use a card reader. In each of the card-not-present cases above, even if a card is with the customer, the electronic data (the data on the magnetic strip, chip, or token) wasn't provided with the transaction, which makes it “card-not-present.”

Embodiments of the present disclosure are best understood when read in conjunction with the accompanying drawings.

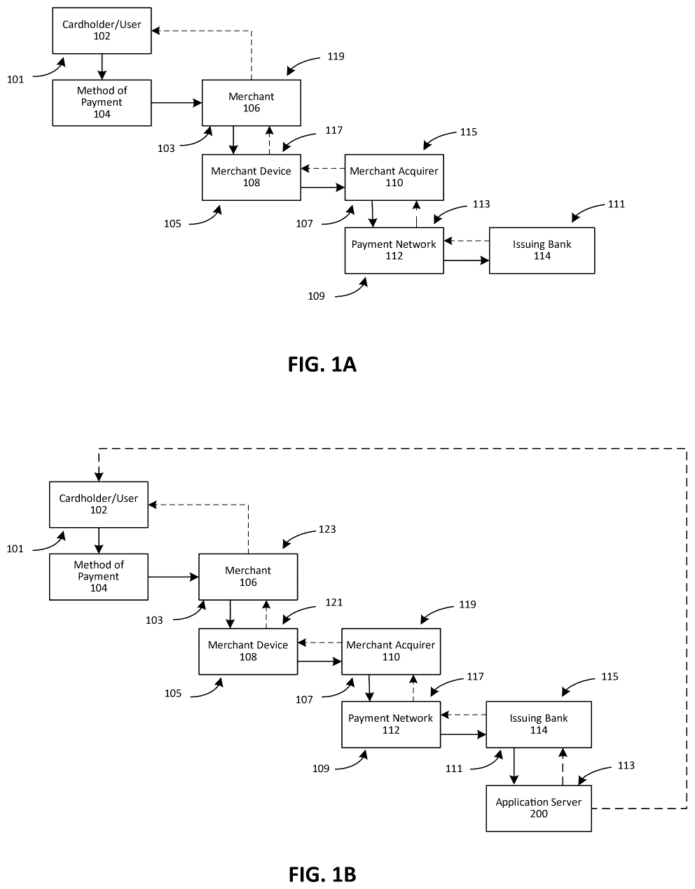

FIG. 1A illustrates a block diagram of the steps commonly used to process electronic financial transactions. The process begins at step 101 when cardholder 102 presents the method of payment 104 to merchant 106 to pay for their purchase. Sensitive card data is stored on the card in the form of a unique identifier known as a token. The merchant collects the card information by swiping or inserting the physical card into merchant device 108 at step 103. Alternatively, merchant 106 may manually enter the card details into an online merchant checkout system. An increasing number of merchant devices 108 are equipped to collect card information with near-field communication (NFC) technology in a process more commonly referred to as a contactless payment or Tap-to-Pay. Cardholder 102 simply taps their physical card or selects a card from the cards saved to the mobile wallet of their device and holds the mobile device over merchant device 108 at step 103. Merchant device 108 collects tokenized data from the method of payment 104 and performs basic data verification. In any case, merchant device 108 combines the collected card information with the merchant identification and transaction data to create a payment authorization request (authorization request), which is then transmitted to merchant acquirer 110 at step 105. Merchant acquirer 110 may include a card processing service, an acquiring bank, or an acquiring processor. Merchant acquirer 110 receives, reviews, and reformats the authorization request and submits an encrypted authorization request to payment network 112 at step 107. Payment network 112 further processes the authorization request and forwards an encrypted authorization request to the cardholder's issuing bank 114 at step 109. Issuing bank 114 verifies the account information and the account's available credit balance at step 109. Issuing bank 114 processes the authorization request and forwards the appropriate ‘approved’ or ‘declined’ authorization response to payment network 112 at step 111. Payment network 112 routes the authorization response to the merchant acquirer 110 at step 113. Merchant acquirer 110 forwards the authorization response to merchant device 108, at step 115. Merchant device 108 displays the authorization response to merchant 106 at step 117. Merchant 106 cardholder 102 at step 119.

FIG. 1B illustrates a block diagram of the steps used to process electronic financial transactions where the method of payment 104 is linked to the available credit balance of an aggregated transaction account in accordance with embodiments of the present disclosure. The process begins at step 101 when cardholder 102 presents the method of payment 104 to merchant 106 to pay for their purchase. The merchant collects the card information by swiping or inserting the physical card into merchant device 108 at step 103. Alternatively, merchant 106 may manually enter the card details into an online merchant checkout system. An increasing number of merchant devices 108 are equipped to process card transactions with near-field communication (NFC) technology in a process more commonly referred to as a contactless payment or Tap-to-Pay transaction. Sensitive card data is stored on the card in the form of a unique identifier known as a token. Cardholder 102 simply taps their physical card (or mobile device) or holds it over merchant device 108. Merchant device 108 collects tokenized data from the method of payment 104 and performs basic data verification. In any case, merchant device 108 combines the collected card information with the merchant information and transaction data to create a payment authorization request (authorization request), which is then transmitted to merchant acquirer 110 at step 105. Merchant acquirer 110 may include a card processing service, an acquiring bank, or an acquiring processor. Merchant acquirer 110 receives, reviews, and reformats the authorization request and submits an encrypted authorization request to payment network 112 at step 107. Payment network 112 further processes the authorization request and forwards an encrypted authorization request to the cardholder's issuing bank 114 at step 109. Issuing bank 114 verifies the account information and forwards an authorization request to application server 200 at step 111. Application server 200 processes the authorization request and provides the issuing bank 114 with the appropriate authorization response to the authorization request at step 113. In addition, application server 200 transmits a text message to the user's mobile device and an email to the user containing the transaction information or instructions to cardholder/user 102 at step 113. Issuing bank 114 receives and forwards the appropriate authorization response to payment network 112 at step 115. Payment network 112 forwards the authorization response to merchant acquirer 110 at step 117. Merchant acquirer 110 forwards the authorization response to merchant device 108, at step 119. Merchant device 108 receives and displays the authorization response to merchant 106 at step 121. Merchant 106 retrieves the authorization response from merchant device 108 and informs cardholder/user 102 at step 123.

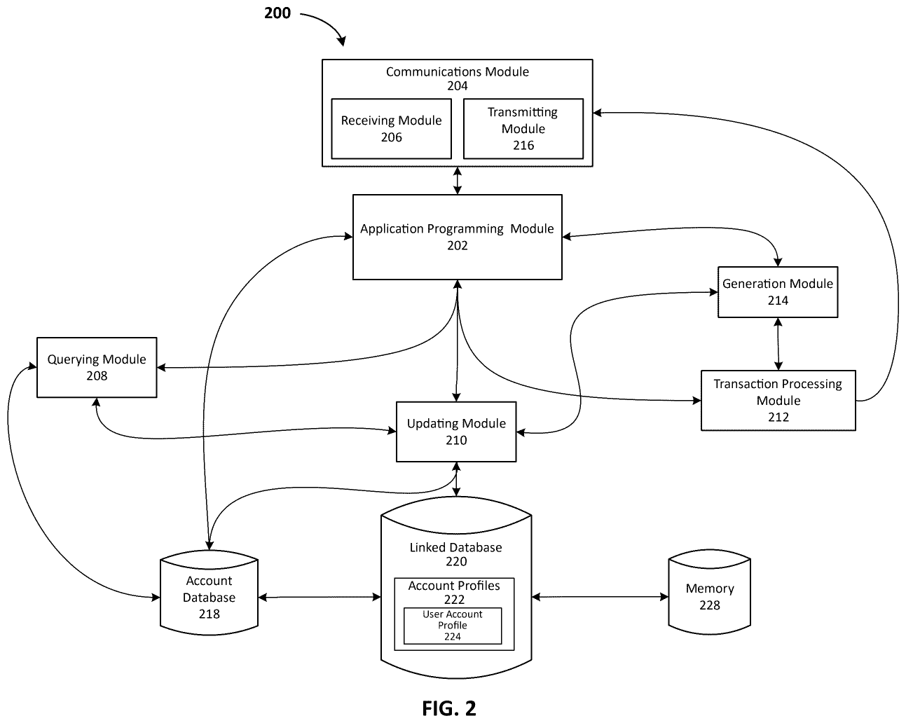

FIG. 2 illustrates embodiments of the invention illustrated in an exemplary environment of the systems and methods used to process electronic financial transactions using a method of payment linked to an aggregated transaction account. Application server 200 is a cloud-based application. It will be apparent to persons having skill in the relevant art that the embodiment of application server 200 illustrated in FIG. 2 is provided as an illustration only and may not be exhaustive of all possible configurations of the application server 200 suitable for performing the functions of the invention. As used herein, the terms “module” and “plugin” may be configured with specialized programming to perform a process or sub-routine consistent with the requirements of one or more embodiments of the invention. Modules and plugins may be programmed to interface with one or more of the modules and plugins of application server 200. Additionally, one or more of the plurality of modules and/or plugins may contain enhanced programming configured to optimize their performance. A module or plugin may include a programming enhancement that would allow direct communication with an external data source as may be required for the function performed by embodiments of the invention. For example, a module or plugin may contain enhanced programming where it can simultaneously transmit multiple data requests and simultaneously receive multiple data responses from one or more data sources in a timely manner and forward the response data to updating module 210 to update the account information contained in the user account profile 224. Programming required to simultaneously transmit and receive data for one or more modules and/or plugins will be apparent to one skilled in the art and understanding of the embodiments of the present disclosure. In some embodiments, application server 200 may include and/or be comprised of a plurality of engines, modules, and/or plugins specially configured to perform one or more functions of the processing device, such as applications programming module 202, Communications Module 204, Querying Module 208, Updating Module 210, Transaction Processing Module 212, and Generation Module 214. Application Server 200 may also contain Account Database 218, Linked Database 220, Account Profiles 222, and one or more forms of Memory 228.

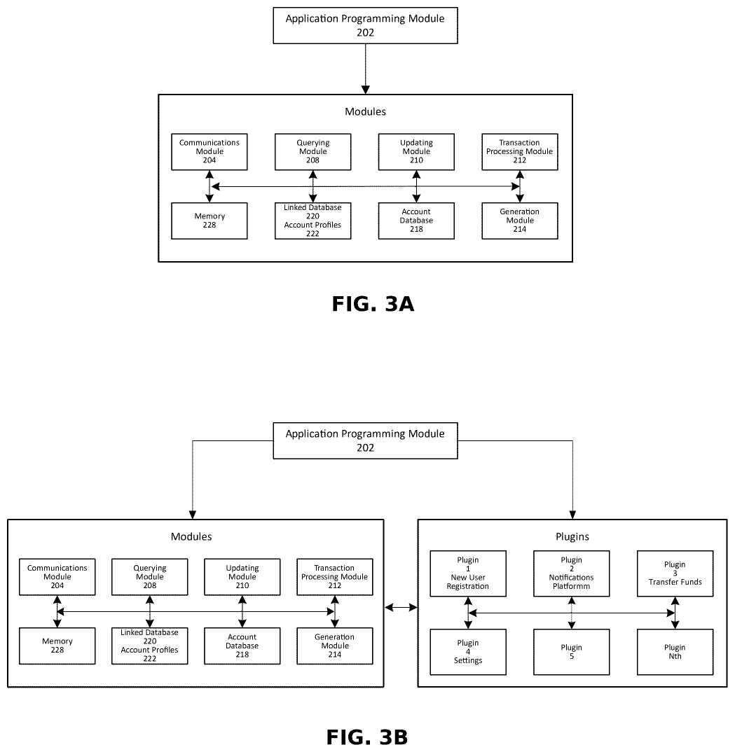

FIG. 3A is a block diagram illustrating a possible example of a modules-only configuration of the application server in accordance with embodiments of the invention. Modular design, or modular architecture, is a design and programming principle that subdivides a system into smaller parts called modules. Each module is a self-contained unit of special-purpose code related to a specific functionality that can be used to perform specific tasks either independently or in conjunction with one or more of the application server's modules to automate tasks or develop solutions by breaking tasks down into smaller, more manageable steps.

FIG. 3B illustrates the possible integration of plugins configured to contain specialized programming and defined interface required to expand, extend, and/or increase the performance capabilities of the application server in accordance with embodiments of an invention. In an embodiment of the invention's programming, application server modules may be configured to use a single plugin or multiple plugins simultaneously. A plugin is not a standalone entity but an extension or add-on that enhances or adds specific functionality to an existing computer program or application. Plugins work by integrating with the host application through a defined interface on top of an application or inside the host program to enhance the capabilities and expand its functionality by leveraging the application's code by integrating with the host application through a clearly defined piece of functionality a backend can optionally implement to extend the capabilities of the host application and provide to the application servers modules without requiring any changes to its core code.

Plugins can be used for a variety of purposes, such as adding new features, increasing security, and the systematic integration of data across the application's modules, APIs, and devices to be more efficient, productive, and agile without altering the structure of the host program itself.

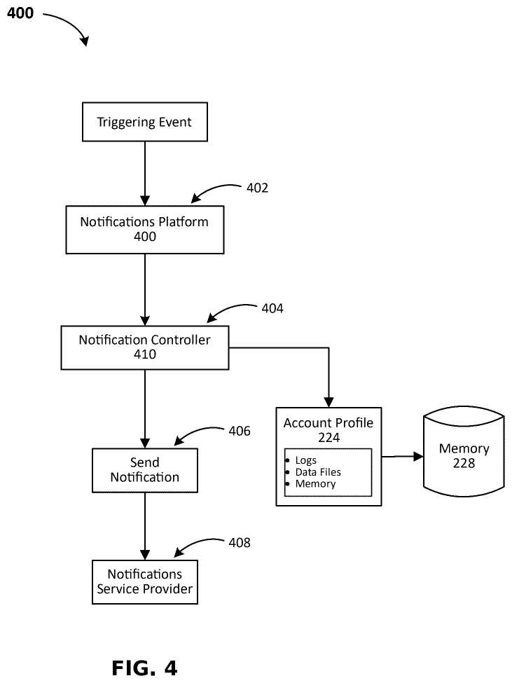

FIG. 4 illustrates a block diagram of the notifications platform 400 of the application programming module 202. FIG. 4 is provided as a procedural reference in lieu of providing a repetitious description of the communication and notification programming required to transmit event-driven data according to embodiments of the invention.

Notifications platform 400, may also be a plugin programmed to communicate with the underlying application that adds a notification feature working on top of the application or inside the application programming module 202 without altering the host program itself. The platform may be integrated into application programming module 202 as an application programming interface (API), where it may be used by the plugins and program modules of the application server 200 to communicate with another program connection having been integrated into host program 230 using a defined interface.

The communication requirements of the API and plugins of the application server 200 may vary and include programming directing it to connect to notifications platform 400. Notifications platform 400 may contain a notification controller 410 programmed to include the policies, procedures, and compliance protocols required by platform programming to authorize the appropriate response to the triggering event.

A triggering event is received by notifications platform 400 and forwarded to the notifications controller 410 at step 402. Notification controller 410 processes the triggering event for procedural compliance according to its governing policies at step 404 and transmits a data signal to the appropriate application, service, or device at step 406. In addition, notifications controller 410 at step 404 updates the logs, data files, and memory of the linked account profile 224. Notification controller 410 may also contain programming to transmit a data signal to a notifications service provider with a request and authorization to send event-driven messaging to the user at step 408. Examples may include transaction related updates confirming a recent purchase, the processing details of a recent transaction, information on a declined transaction, attempted transactions, account connection issues, and directions related to an in-progress transaction, such as try-again messaging.

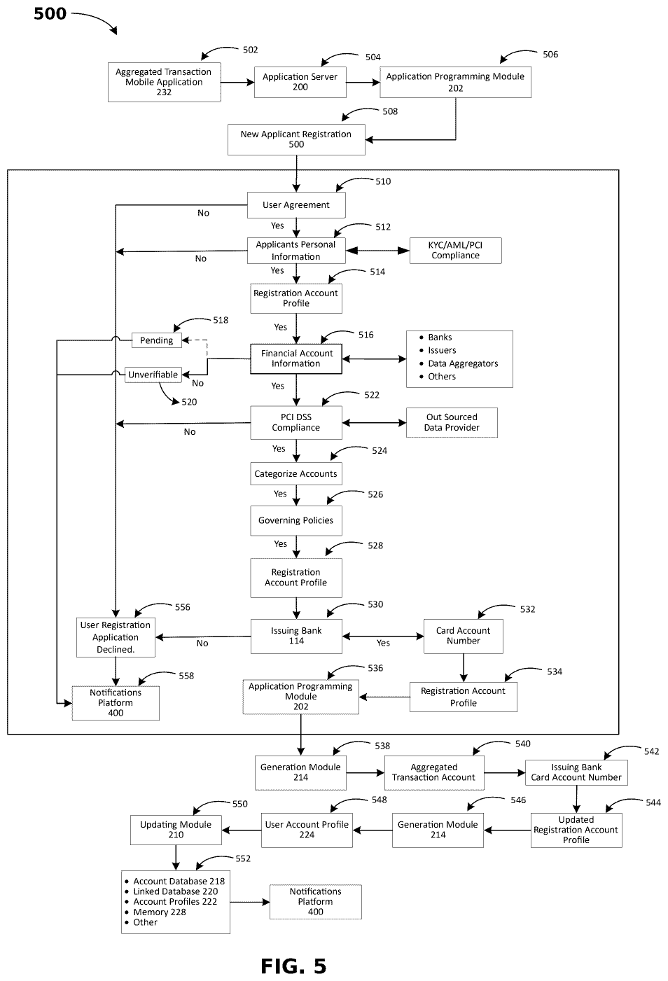

FIG. 5 provides an example of the new applicant registration process in accordance with an embodiment of the present disclosure. The process begins with the applicant downloading aggregated transaction mobile application 700 onto their mobile device and selecting the application icon at step 502. The application transmits an encrypted token to application server 200 of the cloud-based application. Receiving module 206 of communications module 204 at step 504 and forwards the token to application processing module 202 where it is identified as a new user registration at step 506. The application programming module 202 advances the applicant to the user agreement screen. Applicants are asked to review the application's terms, conditions, and policies at step 510. Applicants are required to accept and agree to the user agreement to proceed with the new application registration. Registrants unwilling to accept and agree are unable to continue the registration process. Upon acceptance of the user agreement, the applicant enters their personal information at step 512. The applicant's information is verified and required to satisfy the industry's compliance standards. Know Your Customer (KYC) Anti-Money Laundering (AML), and Payment Card Industry (PCI) compliance standards are mandated by credit card companies to ensure the security of credit card transactions. Upon verification, generation module 214 may assign the applicant a temporary registration account profile associated with the applicant at step 514. The applicant is asked to enter the financial account information for each of the accounts they want to register with the app at step 516. The application's program transmits a data request to each of the respective banks, card issuers, brokerage firms, or other individual financial account providers to verify the account information for each account. In addition, account verification may include data provided by financial data aggregators, or other financial service providers. Accounts may be verified using each method independently or in a combination thereof. Unverifiable accounts are eliminated at step 520. Accounts that have not been verified and require additional attention are directed to and saved in an account pending file at step 518. Verified accounts may be transmitted to an outsourced service provider and reviewed to ensure PCI and DSS compliance at step 522. The registrant is required to classify each of the verified and compliant accounts at step 524. In an example, an account may be categorized as a “transaction account” and used either to process individual payment transactions, or as part of an aggregated payment solution. In addition, accounts may be categorized as a “view only” account and cannot be used to process transactions at step 524. The applicant may be allowed to select and preset the account management default programming from a broad selection of policies, restrictions, and operating procedures options at step 526. Account management programming defaults may be used to process one or more embodiments of the invention. The applicant's registration account profile is updated, encrypted, and forwarded with an approval request to issuing bank 114 at step 528. Issuing bank 114 may receive and evaluate the profile data according to bank policy at step 530 and transmits a response to the approval request. Upon receipt of a declined or unapproved response at step 556 triggers notification platform 400 to transmit a notice to the applicant at step 558. Upon approval, issuing bank 114 assigns a card account number for the approved application and transmits an encrypted data signal at step 532. Application programming module 202 of application server 200 receives and forwards the data signal and updates the registration account profile at step 534. The updated registration account profile and processing authorization are advanced to generating module 214 at step 538. A mandatory embodiment of the invention requires every approved registration account profile to include a unique aggregated account number. Generation module 214 generates and assigns a unique aggregated transaction account number for every approved registration account profile at step 540. The aggregated transaction account number is linked to the applicant's issuing bank card account number at step 542. The registration account profile is further updated and reviewed to confirm the mandatory compliance and registration requirements have been satisfied at step 544. An approved registration account profile is forwarded to generation module 214 at step 214, assigned a new account number, and reclassified as the user account profile 224 of a registered account holder at step 546. The new user account profile 224 is forwarded to updating module 210 at step 548. Account profiles 222 of linked database 220 is updated to include the new user account profile 224. In addition to account database 218, memory 228, or other modules, plugins, forms of memory, and programming required to process embodiments of invention internally or externally at step 550. Having successfully completed the updating requirements triggers notifications platform 400 to transmit an encrypted data signal to activate mobile application 700 and to inform the applicant that mobile application 700 is active and operational at step 552.

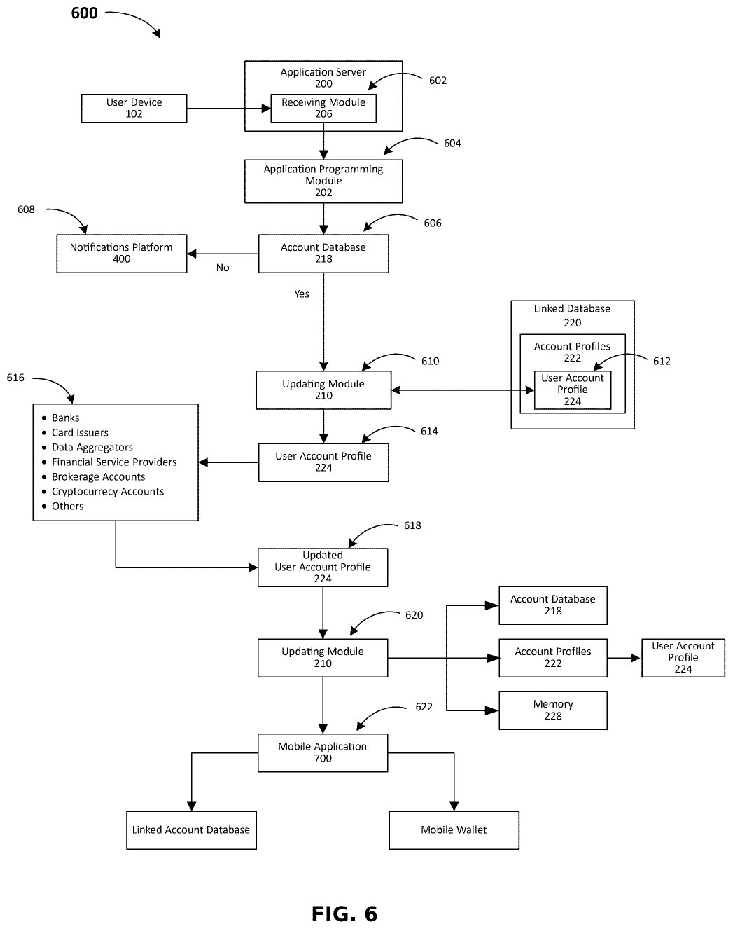

FIG. 6 is a block diagram of a system for processing electronic financial transactions using an aggregated transaction account, in accordance with one or more embodiments of the present disclosure. The systems, methods, and special programming of updating module 210 can be used internally by the modules, plugins, and programming of application server 200. Updating module 210 may be configured to transmit a data request and receive a data response from one or multiple data resources simultaneously. Updating module 210 may also be configured to update user account profile data in response to triggering events received from a verified external program or device. Receiving module 206 of application server 200 receives a data signal from user device 102 containing account information and a request to update related account data from a device at step 602. Receiving module 206 forwards the data signal to application programming module 202 of application server 200 at step 604. Application programming module 202 executes a data search of account database 218 to verify the account information contained in the data signal as a registered account holder at step 606. In one scenario, application programming module 202 is unable to locate and verify an account associated with the account information in account database 218, triggering notification platform 400 to transmit a Declined, No Account On File, Unable to Process, Try Again, etc. response at step 608. In another scenario, account database 218 verifies the account information and forwards the verified account information with an update request to updating module 210. At step 610 updating module 210 requests user account profile 224 from the plethora of accounts stored account profiles 222 of linked database module 220. User account profile 224 is identified and transmitted back to updating module 210 in response at step 612. User account profile 224 and update request is transmitted to updating module 210 at step 610. Updating module 210 of application server 200 may be configured to receive user account profile 224 data and execute special purpose programming to simultaneously transmit multiple account data requests to the banks, card issuers, data aggregators, financial service providers, brokerage accounts, cryptocurrency accounts, and other registered accounts identified and retrieved from the account information of user account profile 224 at step 614. Updating module 210 may also be configured with special purpose programming to simultaneously receive multiple responses to the account data requests transmitted to the banks, card issuers, data aggregators, financial service providers, brokerage accounts, cryptocurrency accounts, and other registered accounts identified and retrieved from the account information of user account profile 224 and forwarded update accounts at step 616. Updated user account profile 224 is transmitted to updating module 210 at step 618. The updated user account profile data received by the updating module 210 further updates account database 218, user account profile 224 of account profiles 222 of linked database 220 at step 620. In addition, at step 620 updated user account profile 224 is transmitted to user device 102 in response to the update account profile request. Mobile application 700 of user device 102 receives user account profile 224 and proceeds to update the data stored in the linked account database and mobile wallet transaction accounts at step 622.

The proliferation of ecommerce payments is widespread and continues to grow. For an increasing number of consumers, using cards to pay for goods and services has become commonplace. It has become equally common for consumers to have multiple cards and to use them multiple times throughout the day. Selecting the wrong form of payment and having your payment declined can be embarrassing. As a result, it has become increasingly important for consumers to know how much credit they have and the available credit balance for each of their accounts conveniently displayed in one location. A no-frills resource and reference of the financial information consumers need to make an informed decision as they select a method of payment.

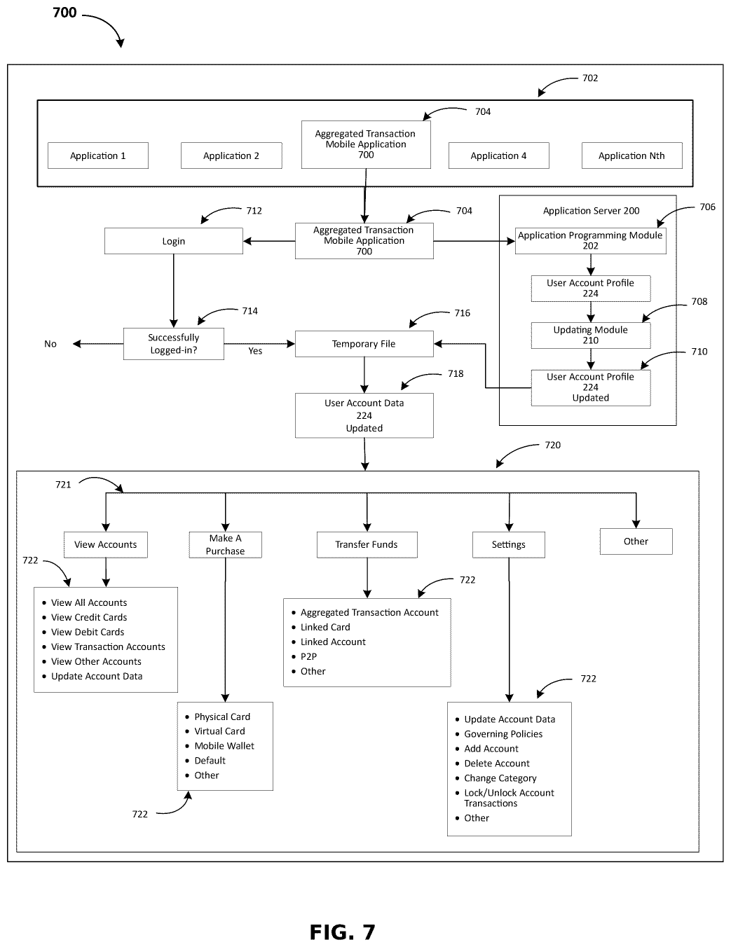

FIG. 7 It is not unusual for a smartphone or tablet to contain multiple applications. FIG. 7 presents a flow chart of aggregated transaction mobile application 700 that has been downloaded onto a mobile device. It is not uncommon for a mobile device to have multiple applications, as depicted at step 702. From the applications available on the mobile device, mobile application 700 is selected at step 704. Programming contained in mobile application 700 advances the mobile device to the login screen of the application at step 712. Application 700 is uniquely configured with special purpose programming to automatically transmit a data signal containing a unique token to application server 200 based on the selection of application 700 on the mobile device and initiated prior to the user having started the process of logging in. The token is uniquely configured to contain identification data and update request to application programming module 202 of application server 200. Application programming module 202 receives the token, verifies the account information with information stored in account database 218, retrieves user account profile 224 of the verified user, and forwards user account profile 224, and update request to updating module 210. In an embodiment of the invention, the application processor is uniquely programmed to transmit multiple data requests and receive multiple data responses from multiple accounts simultaneously in a process that may be used by, but not limited to, applications modules and plugins, individually, collectively, or in cooperation with each other. Updating module 210 transmits a data request to each of the accounts retrieved from user account profile 224 at step 708. Account data received in response to updating module 210 data requests is used to update user account profile 224, account database 218, and memory 228, in addition to providing updated data to any other related module, plugin, or file as may be required by application server 200 programming to support the requirements of the invention. In addition, updating module 210 may transmit an encrypted data signal containing the updated account information in response to the data request at step 710. Application 700 receives the encrypted response, translates the encrypted data into a workable format, and saved to a temporary file of mobile app 700 at step 716. The program proceeds to verify the user's identity before granting access to the application. The user attempts to satisfy the login requirements at step 714. If the user is unable to satisfy the login requirements, the account holder's account management program presets may automatically lock the application and notify the account holder via notification platform 400 of application 700. When a user successfully satisfies the login requirements and is granted access, it signals the temporary file to release data held in temporary file 716 and update the user account data at step 718. Step 720 is presented as an example of the program's flexibility to provide and support a broad array of options, as illustrated at step 721. Step 722 is provided to further illustrate the programming flexibility of the invention to process a subdirectory of features and settings that may be required to streamline the performance of a selected option.

A mobile application may also be referred to as a computer program or computer application. There are differences between a computer program (or computer application) and a mobile application. Mobile applications are specifically designed for mobile use and can only be installed and used on mobile devices, such as smartphones and tablets.

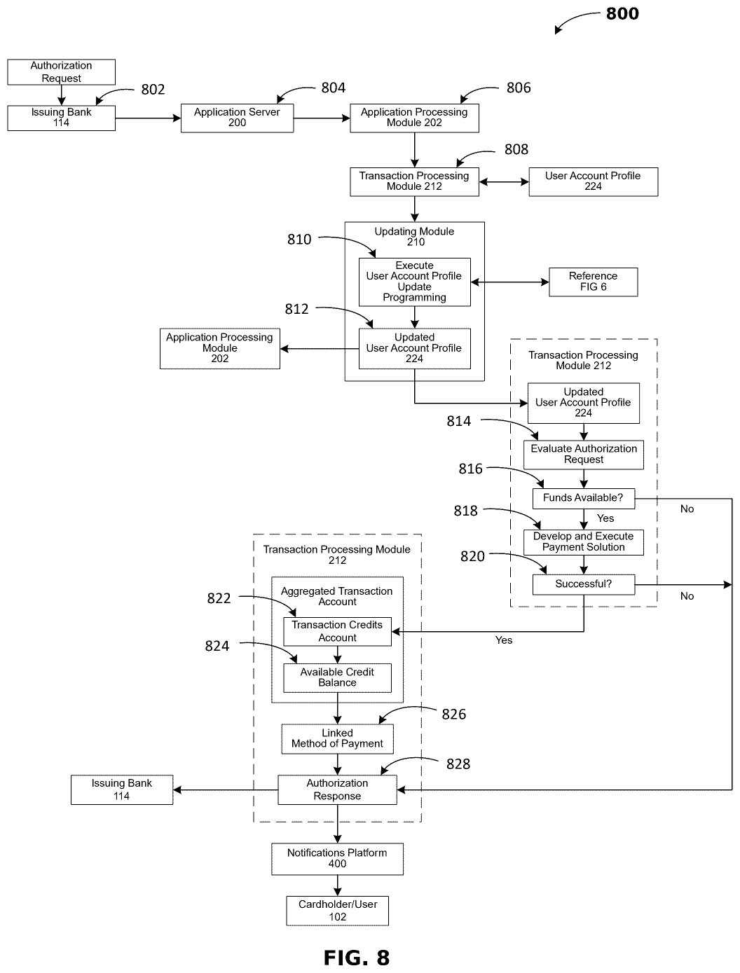

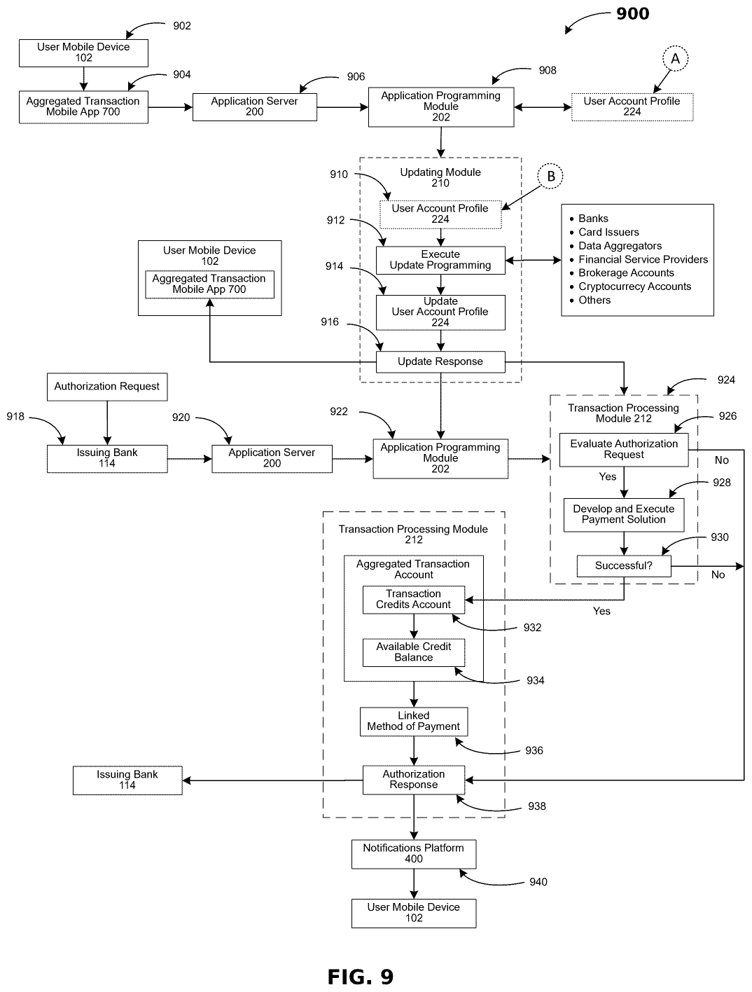

FIG. 8 illustrates an exemplary block diagram of the system for processing a card present electronic financial transactions where the method of payment is linked to an aggregated transaction account in accordance with embodiments of the present disclosure.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. I claim all of the above subject matter.
